(19) United States
(12) Patent Application Publication
(10) Pub. No.: US 2025/0208891 A1
(43) Pub. Date: Jun. 26, 2025

(54) FALLBACK KEY ENCRYPTION KEY RECOVERY FOR CLOUD INFRASTRUCTURE

(71) Applicant: DELL PRODUCTS L.P., Round Rock, TX (US)

(72) Inventors: Ankit Singh, Bangalore (IN); Deepaganesh Paulraj, Bangalore (IN)

(21) Appl. No.: 18/390,155

(22) Filed: Dec. 20, 2023

(51) Int. Cl. G06F 9/455; H04L 9/08

(52) U.S. Cl. CPC G06F 9/45558; H04L 9/0822; G06F 2009/45587

(57) ABSTRACT

An information handling system includes a host environment coupled to a host network and a baseboard management controller (BMC) coupled to a management network. The host environment includes a storage device that is identified by a unique identifier. The BMC receives the unique identifier, provides the unique identifier to a key management server via the management network, receives an encryption key based on the unique identifier from the key management server via the management network, and unlocks the storage device with the encryption key.

### FIELD OF THE DISCLOSURE

This disclosure generally relates to information handling systems, and more particularly relates to providing fallback key encryption key (KEK) recovery in a cloud infrastructure of information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a host environment coupled to a host network and a baseboard management controller (BMC) coupled to a management network. The host environment may include a storage device that is identified by a unique identifier. The BMC may receive the unique identifier, provide the unique identifier to a key management server via the management network, receive an encryption key based on the unique identifier from the key management server via the management network, and unlock the storage device with the encryption key.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIGS. 1-3 are block diagrams of a computer system network according to an embodiment of the current disclosure;

FIG. 4 is a block diagram of a computer system network according to another embodiment of the current disclosure; and

FIG. 5 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

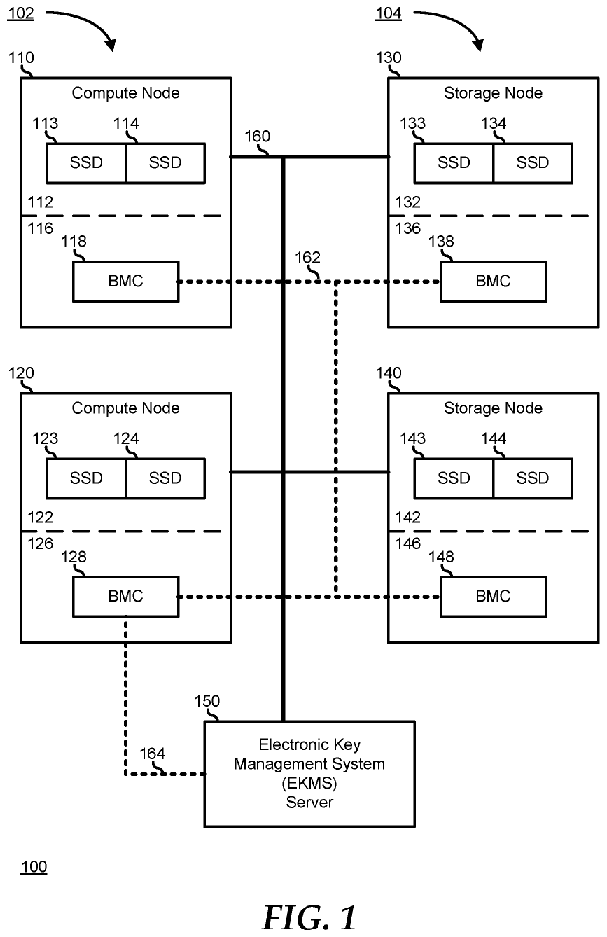

FIG. 1 illustrates a block diagram of a computer network system 100. Computer network system 100 includes compute nodes 110 and 120, storage nodes 130 and 140 and an electronic key management system (EKMS) server 150. Compute node 110 includes a host environment 112 with a multiple storage devices (SSDs) 113, and 114, and a management environment 116 with a baseboard management controller (BMC) 118. Compute node 120 is similar to compute node 110, and includes a host environment 122 with multiple SSDs 123, and 124, and a management environment 126 with a BMC 128. Storage node 130 includes a host environment 132 with a multiple SSDs 133, and 134, and a management environment 136 with a BMC 138. Storage node 140 is similar to storage node 130, and includes a host environment 142 with multiple SSDs 143 and 144, and a management environment 146 with a BMC 148.

Compute nodes 110 and 120, and storage nodes 130 and 140 may each represent information handling systems or computing devices, such as, a personal computer, a workstation computer, a server computer, an enterprise server computer, a laptop computer, a tablet computer, a smartphone, etc. Typically, however, compute nodes 110 and 120, and storage nodes 130 and 140 represent server computers, enterprise systems, or chassis mounted compute blades or sleds, or the like, or other types of systems which may typically be found in a data center type application. Compute nodes 110 and 120 are typically provided as compute centric systems configured to provide processing for various applications and programs that are hosted on the compute nodes. In contrast, storage nodes 130 and 140 are typically provisioned with large storage capacities to provide data storage for the compute nodes 110 and 120. In a particular embodiment, compute nodes 110 and 120 may be configured to run virtualization software, such as VMware ESXi, Microsoft Hyper-V, RedHatR Kernel-based Virtual Machine (KVM), or the like.

Host environments 112, 122, 132, and 142 represent processing environments of respective nodes 110, 120, 130, and 140 that are instantiated on the hardware of the nodes, and that may be typified by a Basic Input/Output System/Universal Extensible Firmware Interface (BIOS/UEFI) and an operating system (OS). As such, host environments 112, 122, 132, and 142 may be understood to provide the operating environments for providing the functions and features associated with the programs that are instantiated on nodes 110, 120, 130, and 140. For example, compute nodes 110 and 120 may be provided to host a website or a database application. In this regard, host environments 112 and 122 would be understood to instantiate the programs associated with the website or database. On the other hand, host environments 132 and 142 may be understood to instantiate the programs associated with the operations of storage nodes 130 and 140. Host environments 112, 122, 132, and 142 are connected together by a host network 160. Host network 160 represents one or more high-speed data communication interface, such as an Ethernet network, a Fibre Channel network, or the like.

SSDs 113, 114, 123, 124, 133, 134, 143, and 144 represent data storage devices associated with respective host environments 112, 122, 132, and 142. SSDs 113, 114, 123, 124, 133, 134, 143, and 144 each include a solid-state memory architecture, eliminating the need for moving parts found in traditional hard disk drives. This architecture enables faster data access and reduced latency, contributing to overall system performance. SSDs 113, 114, 123, 124, 133, 134, 143, and 144 are equipped with controllers and interface technologies to facilitate high-speed data transfer. This includes support for industry-standard interfaces such as SATA, PCIe, and NVMe, ensuring compatibility with a wide range of computing systems. Host environments 112, 122, 132, and 142 may operate to communicate with one or more of SSDs 113, 114, 123, 124, 133, 134, 143, and 144 over host network 160.

In particular, host environments 112, 122, 132, and 142 my operate to package data transactions associated with SSDs 113, 114, 123, 124, 133, 134, 143, and 144, such as Non-Volatile Memory-Express (NVMe) transactions, as data transactions that are provided in a format that is native to host network 160, such as Ethernet transactions, Fibre Channel transactions, or the like. Such transactions may be referred to as “XoF” transactions, where X refers to the SSD format, and F refers to the network fabric. For example, NVMe transactions that are transmitted over an Ethernet fabric may be referred to as “NVMeoE” transactions. Note that SSDs 113, 114, 123, 124, 133, 134, 143, and 144 each include an identifier that uniquely identifies each one of the SSDs. For example, each one of SSDs 113, 114, 123, 124, 133, 134, 143, and 144 may include a Globally Unique ID (GUID), a unique model and serial number, or another unique identifier, as needed or desired.

EKMS server 150 is a cryptographic system that manages the lifecycle of cryptographic keys for computer network system 100. EKMS server 150 provides a secure and centralized way to generate, store, distribute, and destroy keys, and incorporates algorithms for key generation, secure key distribution mechanisms, policy-based access controls, and comprehensive auditing features to facilitate the secure exchange of cryptographic material. In a particular embodiment, SSDs 113, 114, 123, 124, 133, 134, 143 and 144 are dynamically associated with various virtual machines (VMs) instantiated on host systems 112 and 122. These associations, referred to as virtual disks (VDs) can include SSDs that are located on compute nodes 110 or 120, on storage nodes 130 or 140, or any combination thereof. Storage drives 113, 114, 123, 124, 133, 134, 143 and 144 are encrypted using a master encryption key (MEK) and the MEKs reside on each disk.

The MEKs are unique to each disk. For security purposes, each of the MEKs are encrypted using key encryption keys (KEKs) and the KEKs are stored on the cloud infrastructure, for example, in EKMS server 150. In an example, KEKs pertinent to host systems 112 and 122 are retrieved over host network 160 from EKMS server 150. In particular, host systems 112 and 122 provide the unique identifiers for respective SSDs 113, 114, 123, and 124 to EKMS server 150, and the EKMS server retrieves the associated KEKs based on the unique identifiers. The KEKs are then transmitted to the respective storage drives 113, 114, 123, and 124 and are employed to decrypt the MEKs. The MEKs are then used to encrypt or decrypt the data present in storage drives 113, 114, 123, and 124. The transfer of KEKs from the host to storage drives 113, 114, 123, and 124 to decrypt MEKs is limited to the SSDs attached locally to compute nodes 110 and 120 and not for the SSDs over network in cloud infrastructure, i.e. storage nodes 130 and 140. To decrypt data on SSDs 133, 134, 143 and 144, storage nodes 130 and 140 establish direct communication with EKMS Server 150 to retrieve the requisite KEKs. Host network 160 may represent one or more physical networks, each with different network fabrics, as needed or desired. As such, the network paths utilized by host nodes 110 and 120 to access EKMS server 150 may differ from the network paths utilized by storage nodes 130 and 140 to access the EKMS server.

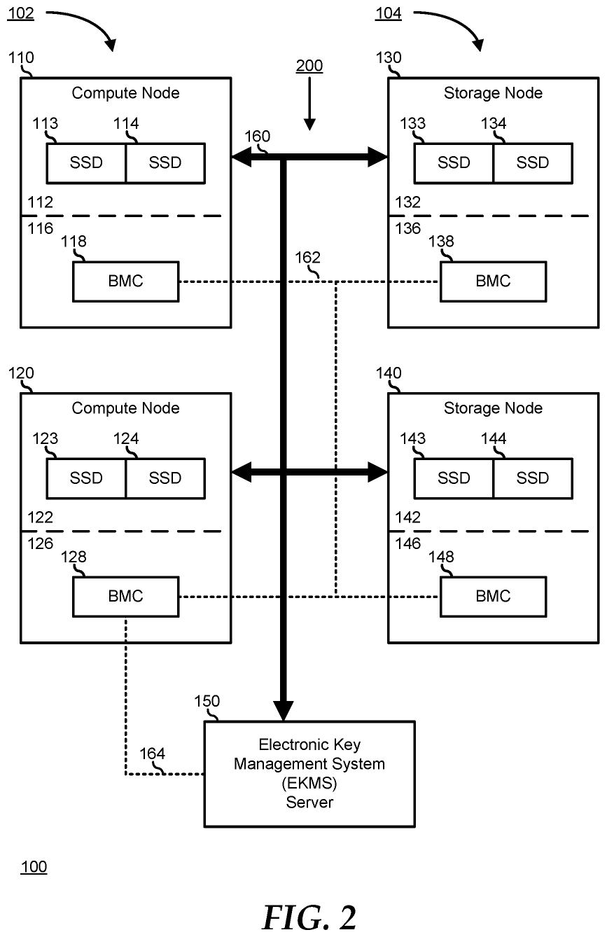

FIG. 2 illustrates a method 200 for unlocking SSDs 113, 114, 123, 124, 133, 134, 143, and 144 on computer network system 100. In an example, the KEKs pertinent to host systems 112 and 122 are retrieved over host network 160 from EKMS server 150. The KEKs are then transmitted to respective storage drives 113, 114, 123, and 124 and further employed to decrypt the MEKs. The MEKs are then used to encrypt or decrypt the data present in storage drives 113, 114, 123, and 124. The transfer of KEKs from the host to storage drives 113, 114, 123, and 124 to decrypt the MEKs is limited to the SSDs attached locally to compute nodes 110 and 120 and not for the SSDs over network in cloud infrastructure, i.e. storage nodes 130 and 140. To decrypt data on SSDs 133, 134, 143 and 144, storage nodes 130 and 140 establish direct communications with EKMS Server, to retrieve the requisite KEKs.

Returning to FIG. 1, management systems 116, 126, 136, and 146 represent management environments of respective nodes 120, 130, 140, and 150. BMCs 118, 128, 138 and 148 are each connected to multiple elements of respective nodes 110, 120, 130, and 140 to monitor, manage, and maintain the elements of the nodes, as needed or desired. In particular, BMCs 118, 128, 138, and 148 operate out of band from respective host environments 112, 122, 132, and 142 and are connected together via a management interface 162 to provide out of band monitoring, maintenance, and control of the elements of the information handling system. As such, BMCs 118, 128, 138, and 148 represent processing devices which provide various management functions for computer network system 100. For example, BMCs 118, 128, 138, and 148 may be responsible for power management, cooling management, and the like, as described further below. BMC 128 is illustrated as being connected by a side-band network 164 to EKMS server 150. One or more of BMCs 118, 128, 138, and 148 may likewise be connected to EKMS server 150, as needed or desired.

When the KEKs are retrieved over host network 160 from EKMS server 150, there is a risk of unavailability of one or more of SSDs 113, 114, 123, 124, 133, 134, 143, and 144 to host systems 112, 122, 132, and 142, and to EKMS server 150. This risk of unavailability is because the KEKs are fetched through multiple paths, and any of the paths could fail due to the reasons including but not limited to network card issue on compute nodes 110 or 120, or on storage nodes 130 or 140, link failure due to any damage to fiber cables or any configuration issue at the host or the storage nodes. For example, when compute node 110 loses its network connection to host network 160, host environment 112 will be unable to retrieve the KEKs associated with SSDs 113 and 114, and the VMs instantiated on the host environment will lose access to the data stored on the SSDs. Likewise, when storage node 130 loses its network connection to host network 160, host environment 132 will be unable to retrieve the KEKs associated with SSDs 133 and 134, and any VMs instantiated on host environments 112 and 122 will lose access to the data stored on the SSDs.

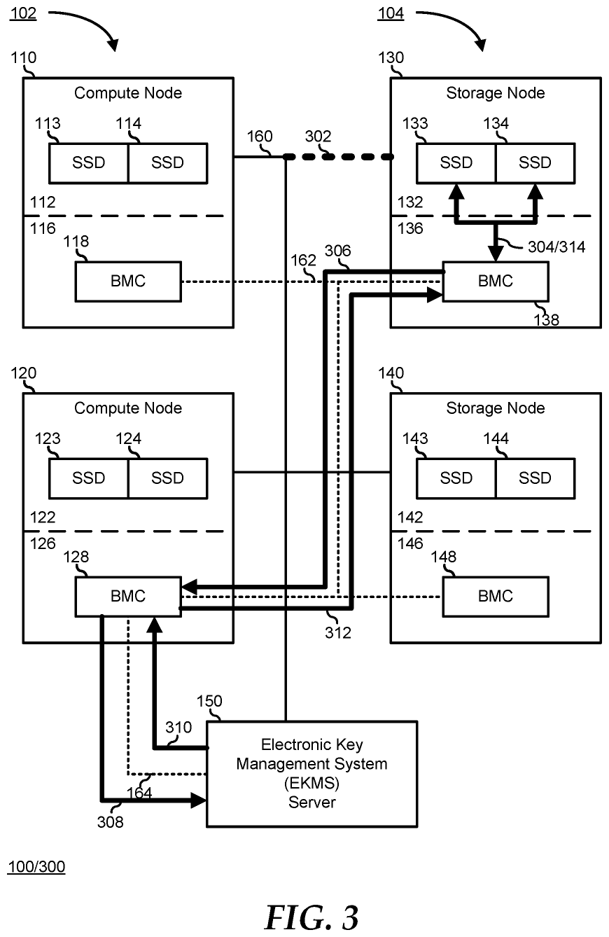

In a particular embodiment, if there is a failure by either compute nodes 110 or 120 or storage nodes 130 or 140 to retrieve KEKs over host network 160, a fallback method may be employed that utilizes management environments 116, 126, 136, and 146, and management network 162. FIG. 3 illustrates such a method 300 for unlocking SSDs 113, 114, 123, 124, 133, 134, 143, and 144 on computer network system 100 when one or more of nodes 110, 120, 130, or 140 loses availability to EKMS server 140. In an exemplary case a network connection of host network 160 to host environment 132 has failed, as illustrated by the dashed line 302. In step 304, when the network connection failure 302 is detected, host environment 130 provides the unique identifiers for SSDs 133 and 134 to BMC 138. In step 306, BMC 138 sends the unique identifiers for SSDs 133 and 134 to BMC 128 via management network 162. In step 308, BMC 128 sends the unique identifiers for SSDs 133 and 134 to EKMS server 150 via side band network 164. In step 310, EKMS server 152 returns the KEKs for SSDs 133 and 134 to BMC 128 via side band network 164. In step 312, BMC 128 returns the KEKs for SSDs 133 and 134 to BMC 138 via management network 162. In step 314, BMC 138 provides the KEKs to respective SSDs 133 and 134 to unlock the SSDs.

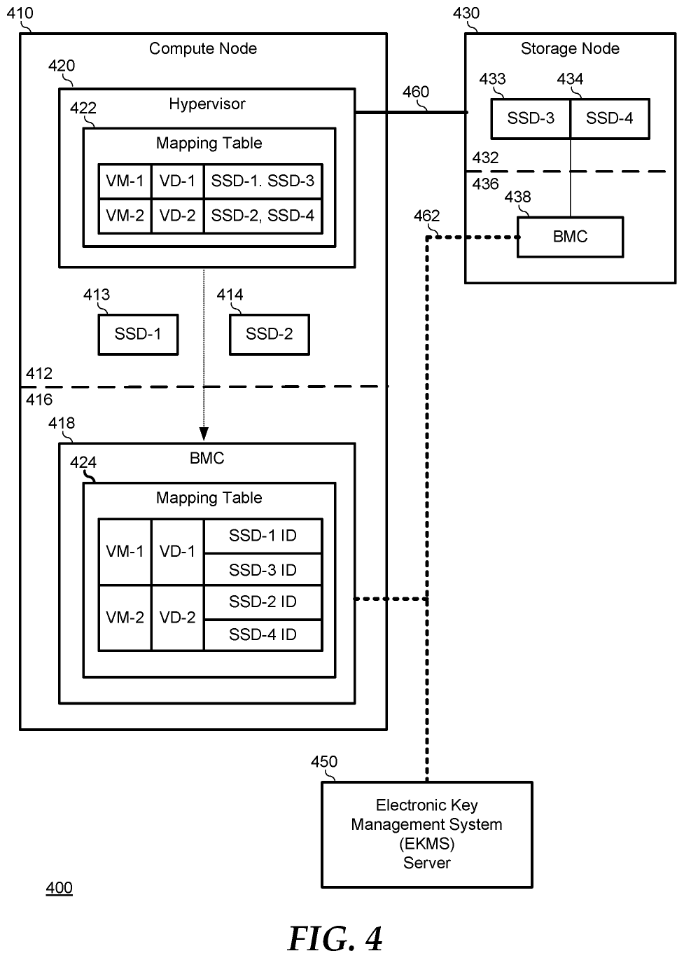

FIG. 4 illustrates a block diagram of a computer network system 400 similar to computer network system 100. Computer network system 400 includes a compute node 410, a storage node 430, and an EKMS server 450. Compute node 410 includes a host environment 412 with a multiple storage devices (SSDs) 413, and 414, and a management environment 416 with a baseboard management controller (BMC) 418. Compute node 410 operates similarly to compute nodes 110 and 120 as described above, except as noted below. Storage node 430 includes a host environment 432 with multiple SSDs 433, and 434, and a management environment 436 with a BMC 438. Storage node 430 operates similarly to storage nodes 130 and 140 as described above. Host environment 412 and 432 represent processing environments of their respective nodes, and are connected via a host network 460 similar to host network 160. EKMS server 450 is similar to EKMS server 150.

Management systems 416 and 436 operate similarly to management systems 116, 126, 136, and 146 as described above, except as noted below. Management systems 416 and 436 are connected via a management network 462, and EKMS server 450 is connected to the management network. Host system 412 includes a hypervisor 420, also referred to as a virtual machine manager (VMM). Hypervisor 420 represents an operating system or software that emulates multiple operating systems (that is, virtual machines) to run on a single information handling system simultaneously, and manages the virtualization of resources of the information handling system such as CPU, memory, and storage. The VMs operate as if they are running on separate physical hardware, allowing users to run different operating systems and applications on the same information handling system. Hypervisor 420 operates to allocate storage media to each VM. In particular, hypervisor 420 creates a virtual disk (VD) for each VM, and allocates physical storage media to each VD. Thus, the mapping of VMs to the VDs involves the association of simulated computing environments (the VMs) with virtual storage spaces (the VDs). Each VM is linked to a corresponding VD, which serves as a simulated storage device. This link enables the VMs to access and store data as if they were using dedicated physical disks. Hypervisor 420 manages the mappings, ensuring that the VMs operate independently and efficiently, with each VD providing a distinct storage space for its associated VM.

After creating the VM to VD mappings, hypervisor 420 operates to allocate physical storage media within computer network system 400 (i.e., SSDs 413, 414, 433, and 434) to the VDs. As illustrated, hypervisor 420 instantiates two (2) VMs, VM-1 and VM-2. Each of VM-1 and VM-2 are mapped in a mapping table 422 to a respective VD-1 and VD-2. Note that when hypervisor 420 instantiates VM-1 and VM-2, the hypervisor operates to allocate physical storage resources to respective VD-1 and VD-2. Thus, as illustrated, VD-1 maps to SSD 413 (SSD-1) in host system 412, and to SSD 433 (SSD-3) in host system 432. Similarly, VD-2 maps to SSD 414 (SSD-2) in host system 412, and to SSD 434 (SSD-4) in host system 432.

In a particular embodiment, BMC 418 includes a mapping table 424 similar to mapping table 422. Hypervisor 420 operates to provide the information from mapping table 422 to BMC 418 to populate a mapping table 424. BMC 418 then operates to retrieve the unique identifiers for SSDs 413, 414, 433, and 434. In particular, BMC 418 retrieves the unique identifiers for SSDs 413 and 414 locally from host system 412, retrieves the unique identifiers for SSDs 433 and 434 from BMC 438 via management network 462, and populates mapping table 424 with the unique identifiers for the mapped VDs.

In this embodiment, the unlocking of SSDs 413, 414, 433, and 434 is performed between BMCs 418 and 438, and EKMS server 450 over management network 462. For example, hypervisor 420 populates mapping table 422. Thereafter, hypervisor 420 operates to provide the information from mapping table 422 to BMC 418 and the BMC populates mapping table 424. Hypervisor 420 then sends the unique identifiers for SSDs 413 and 414 to BMC 418. Once BMC 418 receives the unique identifiers, they are further transmitted to EKMS server 450 to retrieve corresponding KEKs for respective SSDs 413 and 414. EMKS server 450 then transmits KEKs for unlocking SSDs 413 and 414 to BMC 418, thereby enabling the unlocking of SSDs. In unlocking SSDs 433 and 434, in a first case, BMC 418 directs BMC 438 to provide the unique identifiers for SSDs 433 and 434. Then BMC 418 transmits the unique identifiers to EKMS server 450, receives the associated KEKs, and forwards the KEKs to BMC 438. Finally, BMC 438 provides the KEKs to SSDs 433 and 434. In another case, BMC 418 directs BMC 438 to retrieve the KEKs for SSDs 433 and 434 directly from EKMS server 450.

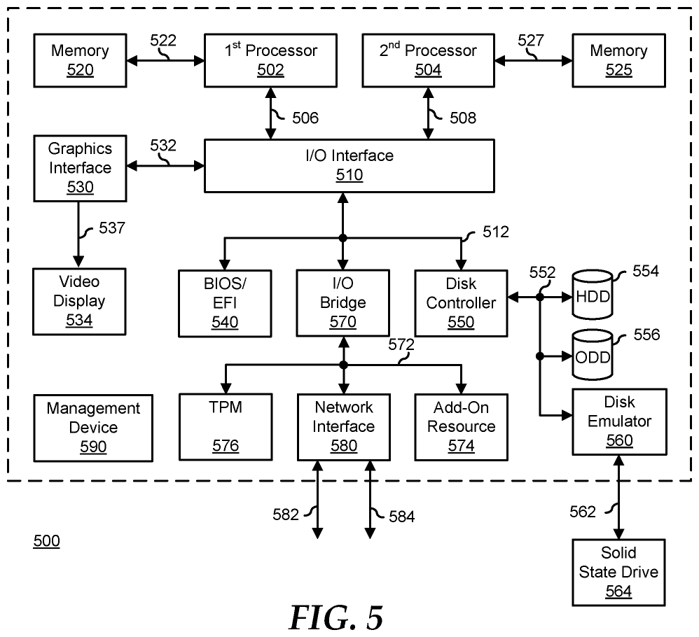

FIG. 5 illustrates a generalized embodiment of an information handling system 500. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below, and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 564, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 564, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532, and provides a video display output 536 to a video display 534. In a particular embodiment, information handling system 500 includes separate memories that are dedicated to each of processors 502 and 504 via separate memory interfaces. An example of memories 520 and 525 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 2394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512, or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500. Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a first host environment coupled to a host network, the first host environment having a first storage device that is identified by a first unique identifier; and
a first baseboard management controller (BMC) coupled to a management network, the first BMC being configured to receive the first unique identifier, to provide the first unique identifier to a key management server, to receive a first encryption key based on the first unique identifier from the key management server, and to unlock the first storage device with the first encryption key.

2. The information handling system of claim 1, wherein receiving the first unique identifier is in response to determining that the first host environment is isolated from the host network.

3. The information handling system of claim 1, wherein receiving the first unique identifier is in response to receiving a mapping of the first storage device to a first virtual machine instantiated by the first host system.

4. The information handling system of claim 1, wherein the first BMC is further configured to receive a second unique identifier that identifies a second storage device from a second BMC via the management network, to provide the second unique identifier to the key management server, to receive a second encryption key based on the second unique identifier from the key management server, and to transmit the second encryption key to the second BMC via the management network.

5. The information handling system of claim 4, wherein receiving the second unique identifier is in response to determining that a second host environment is isolated from the host network.

6. The information handling system of claim 1, wherein the first BMC provides the unique identifier to the key management server and receives the first encryption key from the key management server via the management network.

7. The information handling system of claim 1, wherein the first BMC provides the unique identifier to the key management server and receives the first encryption key from the key management server via a side band network different from the management network.

8. The information handling system of claim 1, wherein the first encryption key is a key encryption key.

9. The information handling system of claim 8, wherein the KEK unlocks a master encryption key stored on the first storage device.

10. A method comprising:
coupling a first host environment of an information handling system to a host network;
providing, in the first host environment, a first storage device that is identified by a first unique identifier;
coupling a first baseboard management controller (BMC) of the information handling system to a management network;
receiving, by the first BMC, the first unique identifier;
providing, by the first BMC, the first unique identifier to a key management server;
receiving, by the first BMC, a first encryption key based on the first unique identifier from the key management server; and
unlocking the first storage device with the first encryption key.

11. The method of claim 10, further comprising receiving, by the first BMC, the first unique identifier in response to determining that the first host environment is isolated from the host network.

12. The method of claim 10, further comprising receiving, by the first BMC, the first unique identifier in response to receiving a mapping of the first storage device to a first virtual machine instantiated by the first host system.

13. The method of claim 10, further comprising:
receiving, by the first BMC, a second unique identifier that identifies a second storage device from a second BMC via the management network;
providing, by the first BMC, the second unique identifier to the key management server;
receiving, by the first BMC, a second encryption key based on the second unique identifier from the key management server; and
transmitting the second encryption key to the second BMC via the management network.

14. The method of claim 13, further comprising receiving, by the first BMC, the second unique identifier in response to determining that a second host environment is isolated from the host network.

15. The method of claim 10, wherein providing the unique identifier to the key management server and receiving the first encryption key from the key management server is via the management network.

16. The method of claim 10, wherein providing the unique identifier to the key management server and receiving the first encryption key from the key management server are via a side band network different from the management network.

17. The method of claim 10, wherein the first encryption key is a key encryption key (KEK).

18. The method of claim 17, wherein the KEK unlocks a master encryption key (MEK) stored on the first storage device.

19. A network of information handling systems, the network comprising:
a first information handling system including a first host environment having a storage device that is identified by a unique identifier, and a first baseboard management system (BMC) that operates out of band from the first host environment;
a second information handling system including a second host environment and a second BMC that operates out of band from the second host environment, wherein the first host environment is coupled to the second host environment by a host network and the first BMC is coupled to the second BMC by a management network; and
a key management server coupled to the host network and to the second BMC;
wherein the first BMC is configured to determine that the first host system is isolated from the host network, to retrieve the unique identifier, and to transmit the unique identifier to the second BMC via the management network;
wherein the second BMC is configured to provide the unique identifier to the key management server, to receive an encryption key for the storage device from the key management server based on the unique identifier, and to transmit the encryption key to the first BMC via the management network; and
wherein the first BMC is further configured to unlock a the storage device with the encryption key.

20. The network of claim 19 wherein the first encryption key is a key encryption key that unlocks a master encryption key stored on the storage device.
